(19) United States
(12) Patent Application Publication
(10) Pub. No.: US 2006/0138854 A1
(43) Pub. Date: Jun. 29, 2006

(54) Wheel balancing device made of zinc or zinc alloy, set of such devices, wheel equipped with same and method for making same

(75) Inventors: Gilles Le Moal, Versailles (FR); Alain Coulaud, Recquencourt (FR)

Correspondence Address: NICOLAS E. SECKEL;Patent Attorney, 1250 Connecticut Avenue, NW Suite 700, WASHINGTON, DC, 20036, US

(73) Assignee: Fonderie De Gentilly, Ris Orangis (FR)

(21) Appl. No.: 10/527,184

(22) PCT Filed: Sep. 10, 2003
(86) PCT No.: PCT/FR03/02689

§ 371 Date: Nov. 14, 2005

(30) Foreign Application Priority Data
Sep. 10, 2002 (FR) 02/11208

(51) Int. Cl. B60B 1/00

(52) U.S. Cl. 301/5.21

(57) ABSTRACT

The invention concerns a wheel balancing device (10) comprising a balancing weight (12) and a clip (11) adapted to be fixed to said wheel, said balancing mass being made of a zinc alloy and being together with the clip, coated with an anticorrosion protective layer (13). The balancing weight is preferably overmoulded on the clip. The coating is preferably obtained by dipping and curing.

The invention concerns the balancing of vehicle wheels fitted with tires.

When fitting a tire to a wheel rim, it is generally necessary to add one or more devices to balance the resulting wheel statically and dynamically at carefully selected locations, usually at the periphery of the rim.

These devices are conventionally balancing weights fixed to the rim by means of a clip. These weights are often made of lead, a material chosen for its high density, and the clips are conventionally made of steel. A weight of this kind and the clip may be joined together when they are fitted to the rim, but it is standard practice for the weight to be fixed to the clip by molding it over the latter during fabrication.

However, lead is a material that has diverse drawbacks, in particular from the human health and environment points of view, as a result of which the need has been expressed to provide balancing devices adapted to withstand high mechanical forces (caused in particular by centrifugal effects when driving at high speed), to balance a wheel quickly and easily, that are advantageously discreet, and that do not have the drawbacks associated with using lead.

European Community Directive 2000/53/CE relating to scrapped vehicles and plans to prohibit the use of balancing devices based on lead as soon as possible are relevant in this context.

It has already been proposed to use wheel balancing devices in which the weight is based on tin, as in the document WO-99/55924 in particular, or aluminum or magnesium alloy (see U.S. Pat. No. 5,350,220). However, these materials are much less dense than lead and in particular have the disadvantages of being relatively costly and of not being available in sufficient quantities to replace lead in all the balancing devices that the automotive industry requires. It has further become apparent, in the case of tin, that there are conditions of use under which this material disintegrates, leading to contamination of the surrounding materials.

In contrast, zinc and zinc alloys are candidate materials of more reasonable cost and available in greater quantities, whilst having a specific gravity comparable to that of tin (approximately 7). However, these materials might seem totally inappropriate because of the phenomenon of galvanic corrosion that may occur because of contact between the material of the balancing weight and the material of the rim (whether that be steel or an aluminum alloy), with the unacceptable risk of deterioration of the weight or the rim.

The invention nevertheless proposes wheel balancing devices including zinc or zinc alloy balancing weights.

To be more precise, the invention proposes a wheel balancing device comprising a balancing weight and a clip adapted to be fixed to said wheel, said balancing weight being made of a zinc alloy and being, together with the clip, coated with an anti-corrosion protective layer.

Note that the coating covers not only the weight but also the clip, which enhances the protection obtained, and makes zinc (usually with at least one alloying element) perfectly suitable for producing balancing devices meeting the stated requirements.

The balancing weight is preferably molded over a portion of the clip, which achieves a good fastening and facilitates the application of a coating to the whole of the clip+weight combination. Other modes of connection are feasible, however, for example crimping.

The material constituting the balancing weight is advantageously a zinc-aluminum alloy, which is a type of alloy that is well known to the person skilled in the art and readily available at reasonable cost, as well as having the necessary physical properties. The alloy may be of the type known by the trade name ZAMAK 5, i.e. containing of the order of 1% by weight copper, but it is preferable to choose an alloy of zinc and aluminum with no copper (i.e. with at most trace amounts of copper), which helps to obtain a low unit cost. The material constituting the balancing weight is preferably an alloy that is very rich in zinc, i.e. containing at least 95% by weight zinc. An alloy that is very suitable for producing devices of the invention is that known under the trade name ZAMAK 3 and containing 96% zinc and 4% aluminum.

The anti-corrosion protection coating may be of various kinds. For example, it may consist of an epoxy resin, a type of coating whose application processes and properties are well known to the person skilled in the art.

However, a preferred alternative protective coating consists essentially of zinc.

A first option is for this protective coating to be obtained by electroplating with zinc.

Another option is for the protective coating to be formed of at least one layer of zinc in a polymerized binder. This can have the advantage of yielding a more matt appearance than coatings obtained by electroplating with zinc. It is even advantageous for the protective coating to be formed of at least two layers of zinc in a polymerized binder, so that a primary deposit may be applied first, followed by a finishing deposit whose appearance is controlled to achieve the required effect.

The coating preferably contains pigments that determine its color. This is much easier if the coating is of zinc in a polymerized binder.

It may be noted here that, because the balancing weights are of a material that is less dense than the lead conventionally used, they are larger for the same weight, whence the benefit of being able to obtain a matt appearance, or even of being able to control the color in order to render these devices as discreet as possible.

The invention further proposes a set of balancing devices of the invention having weights ranging from at least 5 g to at least 60 g, for example in 5 g steps up to a weight exceeding 100 g. It is clear that the balancing operative, using conventional methods, is interested in having various sizes of devices available for use as required, and it is preferable for them all to have the same general composition.

The invention also relates to a wheel comprising a rim and a tire and at least one balancing device of the invention. The wheel preferably comprises at least one balancing device on each side of its rim.

The invention finally proposes a method of fabricating a wheel balancing device comprising the following steps:

making a clip,

molding a zinc alloy balancing weight over this clip,

dipping this clip conjointly with the balancing weight in a bath containing a polymerizable resin charged with zinc,

curing the resin coating the combination of the clip and the balancing weight.

Pigments are preferably placed in the bath. It is advantageous to carry out a second phase of immersion in a bath and a second curing phase (which yield the primary layer and the finishing layer referred to above). One good way to control the thickness of the coating on the clip+weight assembly is to apply a centrifuging treatment between dipping and curing.

Objects, features and advantages of the invention emerge from the following description, given by way of non-limiting illustration:

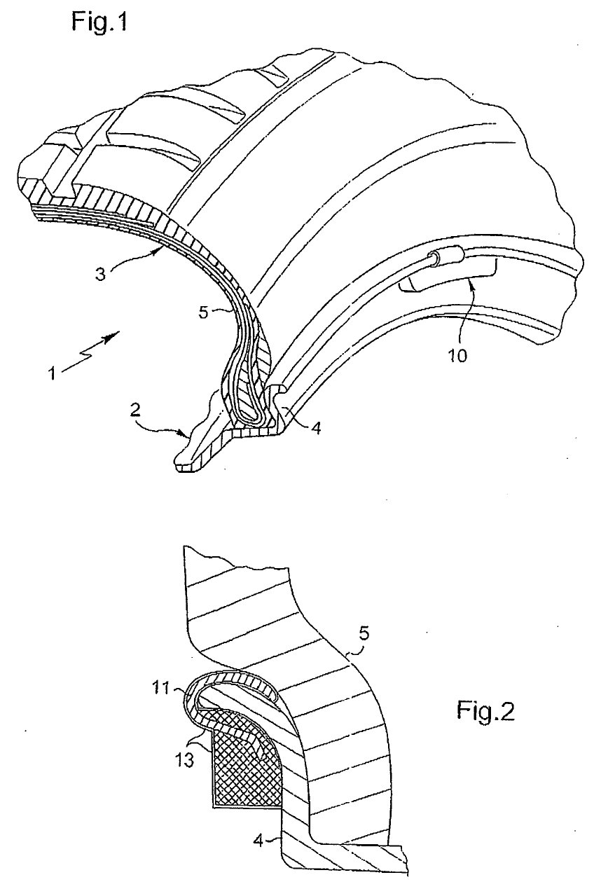

FIG. 1 is a partial view of a wheel comprising a rim, a tire and a balancing device of the invention,

FIG. 2 is a view in cross section of the balancing device mounted on one side of the rim (partially represented), and

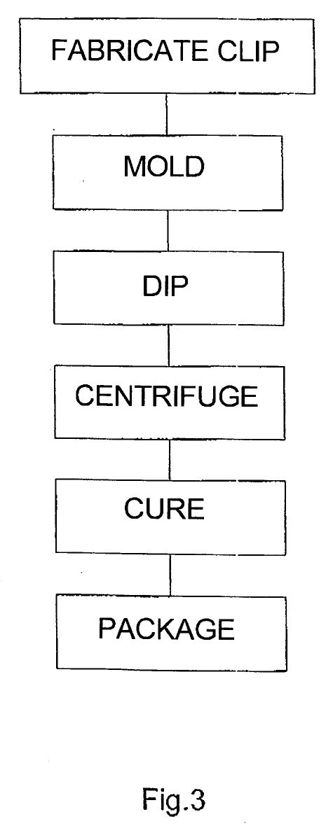

FIG. 3 is a flowchart of a preferred method of fabricating a balancing device of the invention.

FIG. 1 represents a wheel 1 comprising principally a rim 2 and a tire 3. The rim conventionally comprises two sides along the inside of which run the flanks of the tire (FIG. 1 shows only one side 4 and one flank 5). One or more balancing devices 10 provide static and dynamic balancing. In a manner that is conventional in itself, the latter devices are here fixed to a curved part of the side of the rim.

As is clear from FIG. 2, this balancing device 10 includes a clip 11 adapted to be fixed to the wheel and a balancing weight 12 which here is fixed by a molding process.

The clip is conventionally made of steel.

According to the invention, the balancing weight 12 is of a zinc alloy and, together with the clip, is covered with a layer 13 providing protection against mechanical or chemical attack and against corrosion.

This alloy is advantageously a zinc-aluminum alloy, preferably containing no copper. It is advantageously an alloy containing 96% zinc and 4% aluminum.

The coating 13, which therefore covers not only the weight but also the clip, and which therefore isolates the clip, at least in part, from the part of the wheel on which the balancing device is mounted, may be an epoxy resin from 50 to 150 microns thick, for example.

However, the preferred protective coating essentially comprises zinc.

This may be deposited by electroplating with zinc.

However, this coating is preferably formed of one or more layers of zinc in a polymerized binder (or resin), which yields a more matt appearance that is routinely obtained by electroplating with zinc.

To clarify the drawing, the thickness of this coating is exaggerated, since it is preferably from 8 to 15 microns.

Although it has not been possible to show this in FIG. 2, this coating advantageously comprises two (or even more) layers, not only a primary layer providing most of the mechanical and chemical properties, but also a finishing layer yielding the required surface appearance.

It is particularly advantageous if the coating includes pigments determining the color of the balancing device; this color is advantageously grey (for example on an aluminum rim), black (for example on a sheet metal rim), a shade between grey and black, or any other color advantageously chosen to be as close as possible to that of the tire or the rim.

The balancing operative carries out a conventional dynamic test that indicates the location and the weight of a balancing device to be fixed to the wheel under test to dynamically balance it; the test is often duplicated, leading to fixing a balancing device to each side of the rim. As a function of the results of the test, and where applicable of the color of the wheel, the operative chooses the correct device from one or more sets of balancing devices having weights ranging in 5 g steps up to 60 g or more (up to 100 g and beyond). The selected device is fitted in the conventional way by impact (by applying one or two strokes of a mallet).

FIG. 3 shows a preferred method of fabricating a balancing weight in the advantageous embodiment in which the coating is based on zinc and has a matt appearance and a selected color.

A first step, conventional in itself, consists in fabricating the clips.

A second step consists in molding onto each clip a mass of zinc-aluminum alloy (for example the ZAMAK 3 alloy referred to above); this molding operation can be carried out using an installation previously used for molding lead over the clip, subject to thorough cleaning beforehand to eliminate any trace of lead liable to lead to binding of the installation (failing this, the person skilled in the art might prejudge the issue and decide that industrial use of zinc-aluminum alloy is not possible).

In a third step, known as dipping, the parts (clip+weight) are placed in a rack that is immersed for approximately 15 seconds at room temperature in a bath containing zinc, typically in the form of fine flakes, in a polymerizable binder, in order to surround the parts with a layer of the product 5 to 15 microns thick over the whole of their surface.

The parts are then advantageously subjected to a centrifuging step (preferably entailing centrifuging them in both directions) to expel excess product and control the thickness of the coating deposited in this way. This operation takes about 10 to 20 seconds.

Then, during a curing step, the parts are deposited on a belt and placed in a curing furnace for 20 minutes at 200-250° C. to polymerize the layer.

There may be only one layer, but (if justified by the required characteristics (in particular resistance to salt spray, color, etc.)) but it is preferable if a primary layer is deposited followed by a finishing layer, each deposition involving a dipping step, a centrifuging step and a curing step.

For example, a bath of the MAGNY B46 product known in the art is used to produce the primary layer in order to obtain a grey color: inorganic coating (or paint) rich in zinc (zinc flakes). The B18 product is used for the finishing step, in order to obtain the grey color; an epoxy resin organic coating charged with aluminum powder, while the B37 product is used for the finishing step, in order to obtain the black color.

The finishing products serve in particular to delay the onset of “white rust” and offer improved resistance to chemical products.

The primary layer is cured at 250° C. and the finishing layer is preferably cured at a lower temperature, for example 200° C.

It remains only to package these balancing devices so as to make up sets of balancing devices as indicated hereinabove, for example.

1. Wheel balancing device (10) comprising a balancing weight (12) and a clip (11) adapted to be fixed to said wheel, said balancing weight being made of a zinc alloy and being, together with the clip, coated with an anti-corrosion protective layer (13).

2. Device according to claim 1, characterized in that the balancing weight is molded over a portion of the clip.

3. Device according to claim 1 or claim 2, characterized in that the material constituting the balancing weight is a zinc-aluminum alloy.

4. Device according to claim 3, characterized in that the material constituting the balancing weight contains at most trace amounts of copper.

5. Device according to any one of claims 1 to 4, characterized in that the material constituting the balancing weight is an alloy comprising at least 95% by weight zinc.

6. Device according to any one of claims 3 to 5, characterized in that the material constituting the balancing weight contains 96% zinc and 4% aluminum.

7. Device according to any one of claims 1 to 6, characterized in that the protective coating is of epoxy resin.

8. Device according to any one of claims 1 to 6, characterized in that the protective coating comprises essentially zinc.

9. Device according to claim 8, characterized in that the protective coating is obtained by electroplating with zinc.

10. Device according to claim 8, characterized in that the protective coating is formed of one or more layers of zinc in a polymerized binder.

11. Device according to claim 8, characterized in that the protective coating is formed of two or more layers of zinc in a polymerized binder.

12. Device according to any one of claims 7 to 11, characterized in that the coating contains pigments that determine its color.

13. Set of balancing devices according to any one of claims 1 to 12, said devices having weights ranging from at least 5 g to at least 60 g.

14. Wheel comprising a rim, a tire and at least one balancing device according to any one of claims 1 to 12.

15. Wheel according to claim 14, comprising at least one balancing device on each side of its rim.

16. Method of fabricating a wheel balancing device comprising the following steps:
making a clip,
molding a zinc alloy balancing weight over this clip,
dipping this clip conjointly with the balancing weight in a bath containing a polymerizable resin charged with zinc,
curing the resin coating the combination of the clip and the balancing weight.

17. Method according to claim 16, characterized in that pigments are placed in the bath.

18. Method according to claim 16 or claim 17, characterized in that it includes a second phase of dipping in a bath and a second curing phase.

19. Method according to any one of claims 16 to 18, characterized in that centrifuging is effected between dipping and curing.
